(19) United States
(12) Patent Application Publication
(10) Pub. No.: US 2024/0256792 A1
(43) Pub. Date: Aug. 1, 2024

(54) METHODS AND SYSTEMS FOR DYNAMIC GENERATION OF PERSONALIZED TEXT USING LARGE LANGUAGE MODEL

(71) Applicant: Shopify Inc., Ottawa (CA)

(72) Inventors: Russ MASCHMEYER, Berkeley, CA (US); Daniel BEAUCHAMP, Toronto (CA); Miqdad JAFFER, Mississauga (CA)

(21) Appl. No.: 18/180,545

(22) Filed: Mar. 8, 2023

Related U.S. Application Data
(60) Provisional application No. 63/482,403, filed on Jan. 31, 2023.
(60) Provisional application No. 63/483,727, filed on Feb. 7, 2023.

(51) Int. Cl. G06F 40/40; G06F 16/335

(52) U.S. Cl. CPC G06F 40/40; G06F 16/337

(57) ABSTRACT

Methods and systems for automatically prompting a LLM to generate a personalized text, such as a personalized textual description, in which portions of the text are customized based on user attributes. In various examples, responsive to a request for a textual description, a user record is retrieved for a user associated with the request and one or more user attributes are obtained based on the user record. In examples, a prompt to a large language model (LLM) for generating a user-specific textual description is generated, the prompt including the one or more user attributes to include in the generated user-specific textual description and a source text. The prompt is provided to the LLM to receive a generated user-specific textual description. The generated user-specific textual description is provided for display via a user device.

### CROSS-REFERENCE TO RELATED APPLICATIONS

The present disclosure claims priority from U.S. provisional patent No. 63/482,403, filed Jan. 31, 2023, and U.S. provisional patent No. 63/483,727, filed Feb. 7, 2023, the entireties of which are hereby incorporated by reference.

### FIELD

The present disclosure relates to machine learning, and, more particularly, to generation of prompts to large language models (LLM), and, yet more particularly, to prompting an LLM to generate personalized textual descriptions.

### BACKGROUND

A large language model (LLM) is a deep learning algorithm that can process natural language to summarize, translate, predict and generate text and other content. A LLM may be trained to learn billions of parameters in order to model how words relate to each other in a textual sequence. Inputs to a LLM may be referred to as prompts. A prompt is a natural language input that includes instructions to cause the LLM to generate a desired output.

### SUMMARY

Conventionally, to generate a textual description of an object (e.g., a product, a location, an image, a video, a piece of music, a tangible thing, etc.), a user may prompt a LLM to generate an object description. The prompt to the LLM may be simply a list of the object attributes including the object name and optionally other attributes. The prompt may then be inputted into the LLM and the generated text may be directly outputted to the user from the LLM. However, the generated text from the LLM may be generic and static and unlikely to be 100% relevant to all users.

In various examples, the present disclosure provides a technical solution that automatically generates a prompt to cause the LLM to generate a personalized textual description using information about a user or information about a class of users as input to the LLM. In this way, text that could appeal to specific users can be automatically included in the textual description.

In various examples, the present disclosure describes systems and methods that enable a LLM to be prompted to generate a personalized textual description using user attributes (e.g., related to an individual user's preferences and needs) as inputs. Examples of the present disclosure may enable the generated personalized textual description to be automatically or semi-automatically generated, which may provide for greater efficiency and/or reduced need for user inputs. The disclosed solution may improve the performance of e-commerce platforms or merchant websites by presenting textual descriptions to specific users in a manner that is more relevant and appealing to the user.

In some examples, the present disclosure describes a computing system including: a processing unit configured to execute computer-readable instructions to cause the system to: responsive to a request for a textual description, retrieve a user record for a user associated with the request; obtain one or more user attributes based on the user record; generate a prompt to a large language model (LLM) for generating a user-specific textual description, the prompt including the one or more user attributes to include in the generated user-specific textual description and a source text; provide the prompt to the LLM and receive a generated user-specific textual description; and provide the generated user-specific textual description for display via a user device.

In the previous example aspect of the computing system, wherein the processing unit is configured to execute computer-readable instructions to obtain the one or more user attributes based on the user record by: extracting, by a pre-trained attribute extraction model, the one or more user attributes from the user record.

In the previous example aspect of the computing system, wherein the processing unit is configured to execute computer-readable instructions to further cause the system to: retrieve an object record for an object associated with the request; obtain one or more object attributes based on the object record; append the one or more user attributes to the one or more object attributes; and generate the prompt to the LLM for generating the user-specific textual description, the prompt including the one or more user attributes to include in the generated user-specific textual description appended to the one or more object attributes to include in the generated user-specific textual description.

In the previous example aspect of the computing system, wherein the processing unit is configured to execute computer-readable instructions to obtain the one or more object attributes by: extracting, by a pre-trained attribute extraction model, the one or more object attributes that are relevant to the user attributes, from the object record.

In the previous example aspect of the computing system, wherein in extracting the one or more object attributes and the one or more user attributes, the processing unit is configured to execute computer-readable instructions to further cause the system to: determine, by the pre-trained attribute extraction model, one or more priority object attributes from the extracted object attributes; determine, by the pre-trained attribute extraction model, one or more priority user attributes from the extracted user attributes; append the one or more priority user attributes to the one or more priority object attributes; and generate the prompt to the LLM for generating the user-specific textual description, the prompt including the one or more priority user attributes to include in the generated user-specific textual description appended to the one or more priority object attributes to include in the generated user-specific textual description.

In some example aspects of the computing system, wherein the one or more user attributes is an embedding.

In some example aspects of the computing system, wherein the one or more object attributes is an embedding.

In some example aspects of the computing system, wherein the request is a request received from a user device to view a webpage associated with an object, and wherein the processing unit is configured to execute computer-readable instructions to further cause the system to: in response to the request, provide a modified webpage for display via the user device, the modified webpage including the user-specific textual description.

In the previous example aspect of the computing system, wherein data for the webpage stored on the system includes the source text, and wherein the modified webpage provided to the user device has the user-specific textual description substituted in real-time in response to the request.

In some example aspects of the computing system, wherein the source text is a source product description for a product associated with the request, the prompt to the LLM includes instructions to generate a user-specific product description for the product, and the generated user-specific textual description is a generated user-specific product description.

In some example aspects of the computing system, wherein the user record comprises at least one of: a current browsing activity record; a previous transaction event record; a previous browsing activity record; a previous search query; or a user profile.

In some example aspects of the computing system, wherein the user attributes include at least one of: a user demographic attribute; a user preference attribute; or a user need attribute.

In some example aspects of the computing system, wherein the processing unit is configured to execute computer-readable instructions to further cause the system to provide the prompt to the LLM as a set of tokens.

In some example aspects of the computing system, wherein the LLM is a generative pre-trained transformer LLM.

In some examples, the present disclosure describes a computer-implemented method for automatically prompting a LLM to generate a personalized text, the method includes a number of steps. The method comprising: responsive to a request for a textual description, retrieving a user record for a user associated with the request; obtaining one or more user attributes based on the user record; generating a prompt to a large language model (LLM) for generating a user-specific textual description, the prompt including the one or more user attributes to include in the generated user-specific textual description and a source text; providing the prompt to the LLM and receive a generated user-specific textual description; and providing the generated user-specific textual description for display via a user device.

In the previous example aspect of the method, wherein obtaining the one or more user attributes based on the user record comprises: extracting, by a pre-trained attribute extraction model, the one or more user attributes from the user record.

In the previous example aspect of the method, further comprising: prior to retrieving the user record, retrieving an object record for an object associated with the request; obtaining one or more object attributes based on the object record; and generating the prompt to the LLM for generating the user-specific textual description, the prompt including the one or more user attributes to include in the generated user-specific textual description appended to the one or more object attributes to include in the generated user-specific textual description.

In the previous example aspect of the method, wherein obtaining the one or more object attributes based on the object record comprises: extracting, by a pre-trained attribute extraction model, the one or more object attributes that are relevant to the user attributes, from the object record.

In the previous example aspect of the method, wherein extracting the one or more object attributes and the one or more user attributes comprises: determining, by the pre-trained attribute extraction model, one or more priority object attributes from the extracted object attributes; determining, by the pre-trained attribute extraction model, one or more priority user attributes from the extracted user attributes; and generating the prompt to the LLM for generating the user-specific textual description, the prompt including the one or more priority user attributes to include in the generated user-specific textual description appended to the one or more priority object attributes to include in the generated user-specific textual description.

In an example aspect of the method, wherein the one or more user attributes is an embedding.

In an example aspect of the method, wherein the one or more object attributes is an embedding.

In an example aspect of the method, wherein the request is a request received from a user device to view a webpage associated with a product, and wherein the method further comprises: in response to the request, providing a modified webpage for display on the user device, the modified webpage including the user-specific textual description.

In the previous example aspect of the method, wherein data for the webpage stored on the system includes the source text, and wherein the modified webpage provided to the user device has the user-specific textual description substituted in real-time in response to the request.

In an example aspect of the method, wherein the source text is a source product description, the prompt to the LLM includes instructions to generate a user-specific product description for a product associated with the source product description, and the generated user-specific textual description is a generated user-specific product description.

In an example aspect of the method, wherein the user record comprises at least one of: a current browsing activity record; a previous transaction event record; a previous browsing activity record; a previous search query; or a user profile.

In an example aspect of the method, wherein the user attributes include at least one of: a user demographic attribute; a user preference attribute; or a user need attribute.

In an example aspect of the method, further comprising: providing the prompt to the LLM as a set of tokens.

In an example aspect of the method, wherein the LLM is a generative pre-trained transformer LLM.

In some examples, the present disclosure describes a computer-readable medium storing instructions that, when executed by a processor of a computing system, cause the computing system to: responsive to a request for a textual description, retrieve a user record for a user associated with the request; obtain one or more user attributes based on the user record; generate a prompt to a large language model (LLM) for generating a user-specific textual description, the prompt including the one or more user attributes to include in the generated user-specific textual description and a source text; provide the prompt to the LLM and receive a generated user-specific textual description; and provide the generated user-specific textual description for display via a user device.

In some examples, the computer-readable medium may store instructions that, when executed by the processor of the computing system, cause the computing system to perform any of the methods described above.

### BRIEF DESCRIPTION OF THE DRAWINGS

Reference will now be made, by way of example, to the accompanying drawings which show example embodiments of the present application, and in which:

FIG. 1A is a block diagram of a simplified convolutional neural network, which may be used in examples of the present disclosure;

FIG. 1B is a block diagram of a simplified transformer neural network, which may be used in examples of the present disclosure;

FIG. 2A is a block diagram of an example computing system, which may be used to implement examples of the present disclosure;

FIG. 2B is a block diagram illustrating an example Prompt Generator, in accordance with example embodiments of the present disclosure;

FIG. 3 is a flowchart illustrating an example embodiment of a method for automatically prompting a LLM to generate a personalized textual description, in accordance with examples of the present disclosure

FIG. 4 is a flowchart illustrating an example embodiment of a method for automatically prompting a LLM to generate a personalized textual description, in accordance with examples of the present disclosure.

FIG. 5 is a block diagram of an example e-commerce platform, which may be an example implementation of the examples disclosed herein; and

FIG. 6 is an example homepage of an administrator, which may be accessed via the e-commerce platform of FIG. 5.

Similar reference numerals may have been used in different figures to denote similar components.

### DETAILED DESCRIPTION

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publically-available text corpuses may be, e.g., fine-tuned by further training using the complete works of Shakespeare as training data samples (e.g., where the intended use of the ML model is generating a scene of a play or other textual content in the style of Shakespeare).

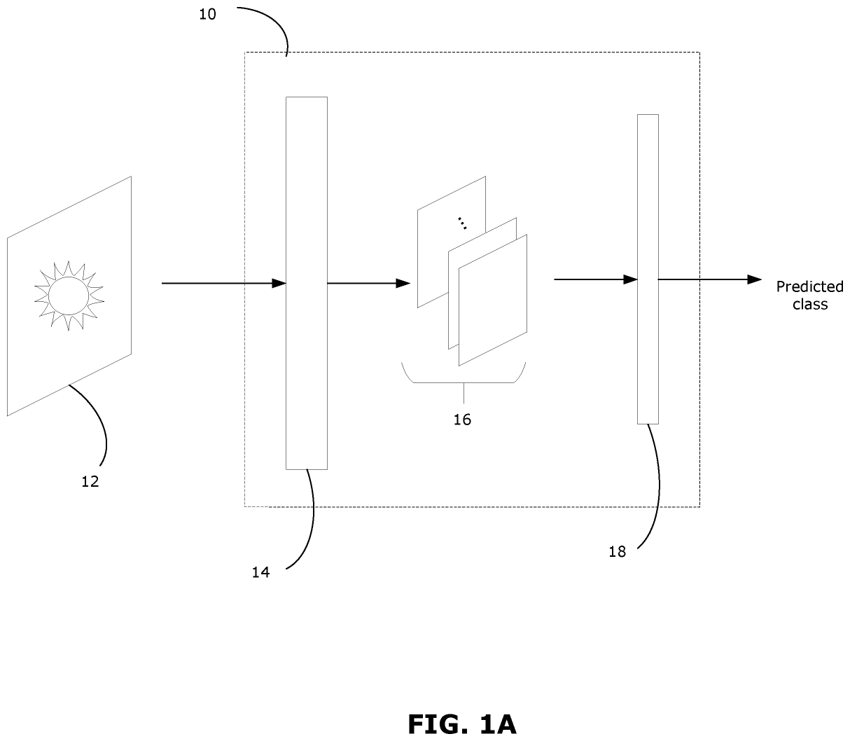

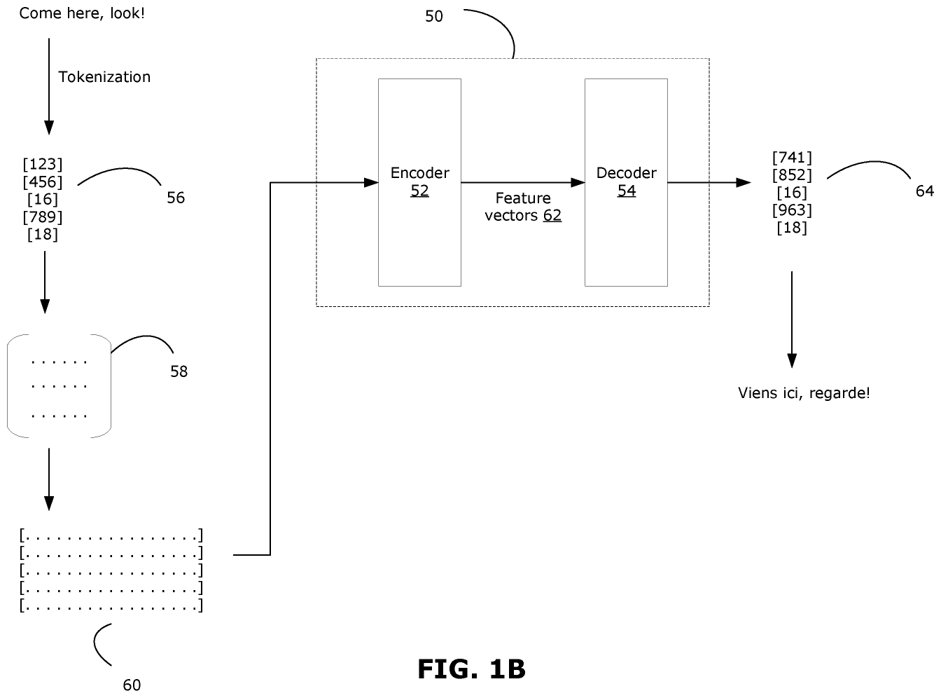

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence. ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

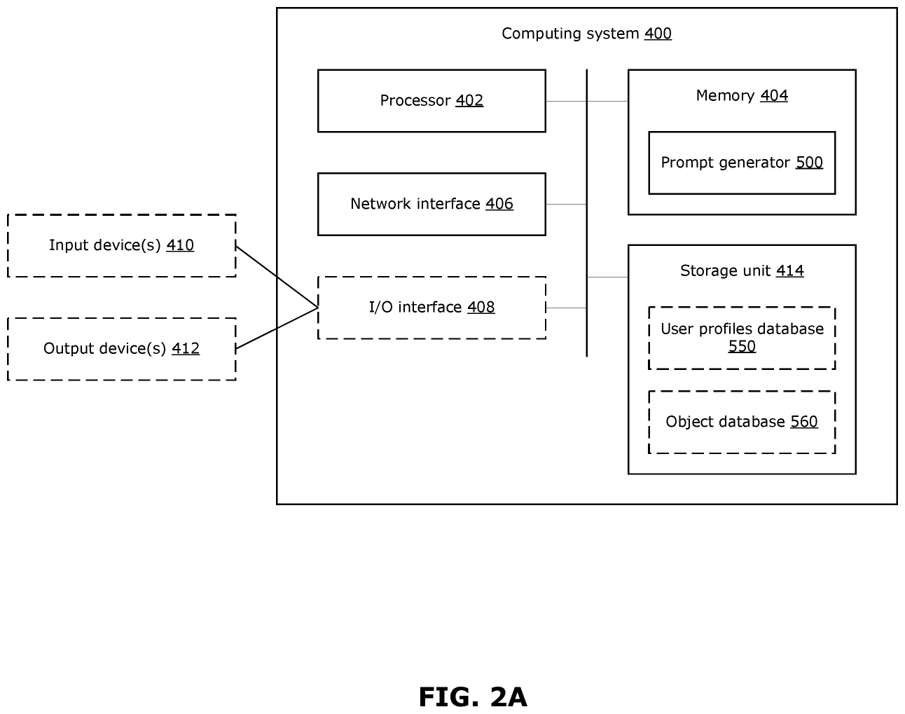

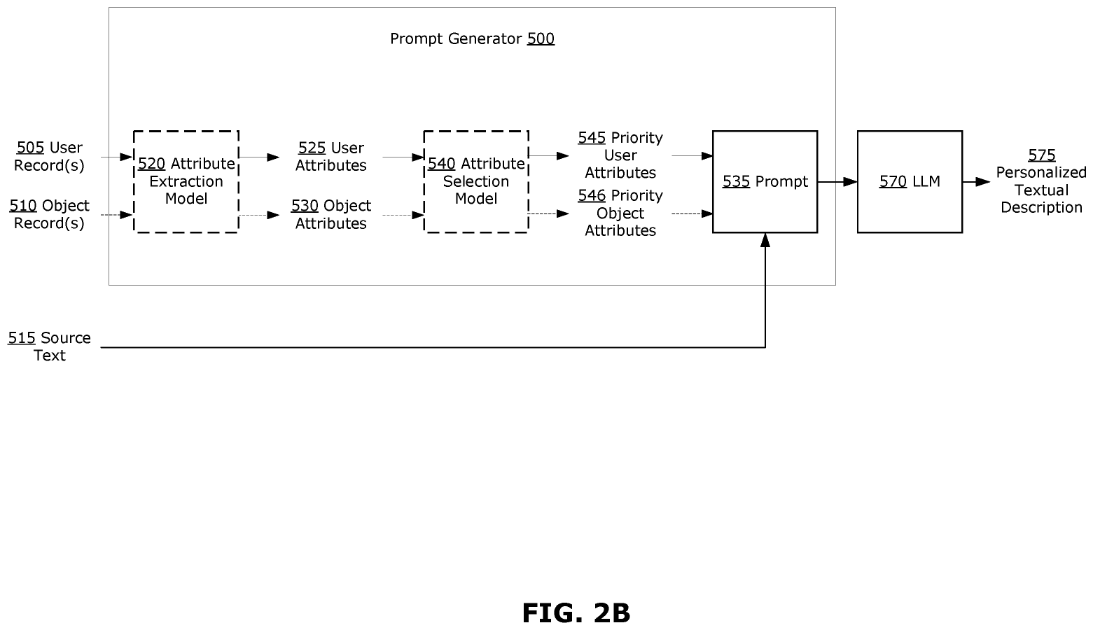

FIG. 2A illustrates an example computing system 400, which may be used to implement examples of the present disclosure, such as a prompt generation engine to generate prompts to be provided as input to a language model such as a LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2A, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

In the example of FIG. 2A, the computing system 400 may store in the memory 404 computer-executable instructions, which may be executed by a processing unit such as the processor 402, to implement one or more embodiments disclosed herein. For example, the memory 404 may store instructions for implementing a prompt generator 500 application, described with respect to FIG. 2B below. In some examples, the computing system 400 may be a server of an online platform that provides the prompt generator 500 as a web-based or cloud-based service that may be accessible by a user device (e.g., via communications over a wireless network). Other such variations may be possible without departing from the subject matter of the present application.

In the example shown, the computing system 400 may store, in the storage unit 414, an optional user profiles database 550 storing a user record(s) 505 (e.g., user profile data) about a plurality of users or classes of users (e.g., cohorts). For example, the user profiles database 550 may include, for each user or cohort, data about one or more user attributes (e.g., characteristics, preferences and/or needs associated with the user or cohort), personal information, purchase history, review history, viewing history, question history and search history, among other data. User attributes for a given user or class of users may, for example, be stored in a lookup table that can be referenced using a unique identifier (e.g., a code, an identification number, an email address or other reference identifying the user, for example, a reference to the user's account or profile) of the user or cohort. Each user attribute of a given user or cohort may be stored as a text string (which may include one or more words).

In the example shown, the computing system 400 may also store, in the storage unit 414, an optional object database 560 storing an object record(s) 510 about a plurality of objects. For example, the object database 560 may include, for each object, data about one or more object attributes (e.g., object name, size, weight, dimensions, color, type, composition, features, specifications or other metadata etc.). Object attributes 530 for a given object may, for example, be stored in a lookup table that can be referenced using the name of the object, a unique identifier (e.g., identification number) of the object, etc. Each object attribute 530 of a given object may be stored as a text string (which may include one or more words). It should be noted that the object database 560 may store other data related to each object, such as an image of the object, a user or account associated with the object, etc. In examples, an object may not be a physical product, but may be a location, or a digital product, or a service, among others, that a user may desire or have a need for and which may be described by one or more attributes.

The data stored in the object database 560 may be labeled by category. It may be noted that the stored data may be unstructured. Additionally, instead of being labeled by category, the data may be labeled by fields or types. For example, each object may have at least an object attribute in the category [object name]. Additional object attributes may include attributes in categories such as [color], [owner], [size], etc. As an example, the object database 560 may store the following object attributes related to a chair: [object name] “ergonomic chair”, [color] “black”, [material] “leather”.

The user profiles database 550 and the object database 560 may be queried by, for example, the prompt generator, as discussed further below. In some examples, the user profiles database 550 and the object database 560 may not be stored locally on the computing system 400 but may instead be a remote database accessible by the computing system 400 (e.g., via a wired or wireless communication link, for example using the network interface 406)

FIG. 2B is a block diagram illustrating an example prompt generator 500 of the present disclosure. The prompt generator 500 may be a software that is implemented in the computing system 200 of FIG. 2A, in which the processor 402 is configured to execute instructions prompt generator 500 stored in the memory 404.

In response to a request, the prompt generator 500 may automatically prompt a LLM to generate a personalized text, such as a personalized textual description 575. In accordance with examples of the present disclosure, a computing system may be a server of an online platform (e.g., SaaS platform) that may provide services to a user device of the user (e.g., over a wireless network) to enable the user to access LLM services for generation of a textual description. The platform may, for example, obtain a source text and a set of user attributes (which may be explicitly inputted by the user or may be automatically extracted from a database (e.g., the user profiles database 550)) and may use the prompt generator 500 to generate a prompt 535. The prompt 535 may be provided to a LLM (e.g., via an API call to a remote LLM) and the generated textual description may be received from the LLM. The platform may then present the generated textual description for display on the user device.

A textual description (e.g., a product description, a description of a photo, a description of an individual, a description of a location etc.) is an important aspect of an e-commerce platform landing page, often serving as the primary text that a buyer will read prior to making a purchase decision. While LLM-based services for generating textual descriptions are available, inputs to the LLM are static (e.g., product attributes from a product catalog or inventory) and the resulting descriptions are generic and unlikely to be 100% relevant to all buyers. For example, a product description is the copy that explains what a product is and why it should be purchased. It is generally preferred for such a textual description to be as relevant as possible to the buyer to help them make an informed choice. The present disclosure refers to the challenge that a LLM does not automatically generate a textual description that appeals to a specific user.

In the present disclosure, the prompt 535 generated by the prompt generator 500 includes instructions to the LLM to include one or more user attributes 525 in the generated textual description so that the generated textual description is a personalized textual description 575 that is customized to the user. Optionally, the platform may, for example, also obtain a set of object attributes 530 (which may be explicitly inputted by the user or may be automatically extracted from a database (e.g., the object database 560)) for inclusion in the prompt 535.

In examples, user attributes may be used to inform not only the content of the personalized textual description 575 but also the style of the personalized textual description 575. In examples, the style of the personalized textual description 575 may include tone of voice (e.g., serious, funny, formal, casual, enthusiastic, adventurous etc.), formatting (e.g., bullets, long-form text, use of emojis, headings, sections, font style, color and size etc.) and length, among others.

In the present disclosure, the term “user attribute” should be understood to refer to characteristics of a user (e.g., a buyer or a potential buyer) or of a cohort, group or category the user may be associated with. In examples, the characteristics of a user may relate to user demographics, for example, obtained from a user record(s) 505 including age, height, geographical location, marital status, gender, skin type, body shape, income, socioeconomic status, life stage, level of education, hobbies, interests and the like. In examples, user attributes obtained from “demographic information” may help to answer the question “who is the buyer?”. Such attributes may be explicitly identified by the user (e.g., inputted in a profile) and/or may be implicitly determined based on the user's behavior (e.g., purchase history, viewing history, etc.).

In examples, the characteristics of a user may also relate to user preferences, for example, obtained from a user record(s) 505 related to past commerce events or transactions (e.g., historic purchases, past browsing history etc.) or past search events (e.g., search query, browser activity, ads clicked on etc.) over an unrestricted or extended timeframe. In examples, user attributes obtained from “user preference information” help to answer the question “what does the buyer like?”

In examples, the characteristics of a user may also relate to user needs, for example, obtained from a user record(s) 505 related to recent commerce events or transactions (e.g., recent purchases, recent browsing history, active cart etc.) or recent search events (e.g., search query, browser activity, ads clicked on etc.) within a more restricted and recent timeframe. In examples, user attributes obtained from “user need information” help to answer the question “what is the user's current need?”

In particular, it should be understood that a user attribute may not be simply the user's purchase history or viewing history, but rather the characteristics of the user him/herself (which may be inferred from the purchase history or viewing history). In some examples, a user's profile may include attributes (e.g., home address) without including any historical information. Conversely, in some examples a user's profile may include historical information (e.g., a past purchase) without including any attributes.

The user record(s) 505 stored in the user profiles database 550 may include a unique identifier (e.g., a code, an identification number, an email address or other reference identifying the user, for example, a reference to the user's account or profile) of the user or cohort. may be labeled by category or may include user attributes labeled by category. For example, each user or cohort may have at least a user attribute in one or more categories, for example, the category [email]. Additional user attributes may include attributes in categories such as [age], [gender], [geographic location], etc. As an example, the user database 550 may store the following user attributes 525 related to a user: [name] “Maria”, [age] “30”, [gender] “woman”, [geographic location] “New York City”.

The user profiles database 550 may be accessed by the prompt generator 500 as discussed further below. In some examples, the user profiles database 550 may not be stored locally on the computing system 400 but may instead be a remote database accessible by the computing system 400 (e.g., via a wired or wireless communication link, for example using the network interface 406).

The object record(s) 510 stored in the object database 560 may be labeled by category or may include object attributes 530 labeled by category. For example, each object may have at least an object attribute 530 in the category [object name]. Additional object attributes 530 may include attributes in categories such as [color], [owner], [size], etc. As an example, the object database 560 may store the following object attributes 530 related to a chair: [object name] “ergonomic chair”, [color] “black”, [material] “leather”.

The object database 560 may be accessed by the prompt generator 500 as discussed further below. In some examples, the object database 560 may not be stored locally on the computing system 400 but may instead be a remote database accessible by the computing system 400 (e.g., via a wired or wireless communication link, for example using the network interface 406).

The prompt generator 500 may obtain a set of one or more user attributes 525 to be included in a generated personalized textual description 575. The prompt generator 500 performs operations to generate a prompt 535 to a LLM to generate the personalized textual description 575, where the prompt 535 includes one or more user attributes 525 that should be included in the generated personalized textual description 575.

The prompt generator 500 may obtain the user attributes 525 in various ways. For example, the set of user attributes 525 may be received as input from the user device (e.g., by a user manually inputting the set of user attribute 525. In another example, the set of user attributes 525 may be obtained from user records 505 stored in the user profiles database 550 (e.g., the user may be associated with a user profile or an account that includes demographic attributes or data associated with past commerce events or transactions etc., and the platform may perform operations to automatically generate a textual description using user data stored in the user profiles database 550).

As previously described, the user record(s) 505 may be obtained from a user profiles database 550. In some cases, a user may be “unknown” and may not be associated with a user account or a user profile (e.g., the buyer may be a first-time buyer), and it may therefore be difficult to obtain specific user attributes 525. In this situation, other attributes (e.g., IP address to determine a geography; browser history tracked by cookies or browser fingerprinting to determine a general area of interest; current browsing history in the current webpage that may be unrelated to cookies etc.) of the unknown buyer not associated with a user profile may be used to identify similar buyers and then attributes from those similar buyers may be used to generate a textual description. In some embodiments, for example, the platform may engage a user-similarity model to infer buyer attributes based on shared behavior or attributes associated with similar buyers.

In another example, at least one user attribute 525 may be partly received from the user device. In examples, the user attribute 525 may also be extracted from other channels, for example, social media channels. In examples, social media channels may provide additional information about a buyer's demographics, preferences or needs, for example, based on what content they interact with, to inform user attributes. In other examples, social media channels may provide additional information about a class of buyers which may be used to inform user attributes.

In some embodiments, for example, user attributes 525 may be extracted from user record(s) 505 by an attribute extraction model 520. Similarly, in some embodiments, for example, object attributes 530 may be extracted from object record(s) 510 by the attribute extraction model 520. In examples, the attribute extraction model 520 may be a trained machine-learning (ML) based model or the attribute extraction model 520 may be a rules-based model, or another model may be used.

In some examples, it may be sufficient for the prompt generator 500 to obtain a minimum of one user attribute 525 (e.g., an age, a gender, a geographic location, etc. or a user class (e.g., retired, parent, runner etc.) to generate a personalized textual description 575. In some examples, there may be no limit to the number of user attributes 525 that can be obtained by the prompt generator 500 for a user; however, there may be a limit to the number of user attributes 525 that the prompt generator 500 can include in a generated prompt 535, for example due to a limit in the number of tokens that the LLM can accept in a prompt 535. In such cases, the prompt generator 500 may select a subset of the obtained user attributes 525 to be priority user attributes 545 that are included in the prompt 535. For example, a user attribute 525 obtained from a linked account in the user profiles database 550 may take priority to be included in the prompt 535 over a user attribute 525 received from the user device or obtained using a user-similarity model. In another example, if the user attributes 525 have category labels, the prompt generator 500 may follow defined rules to prioritize certain categories of attributes for inclusion in the prompt 535. For example, a user attribute in the category [geographic location] may be prioritized over a user attribute in the category [age].

In some embodiments, for example, a pre-trained attribute selection model 540 may determine a subset of user attributes 525 to be priority user attributes 545 or optionally, may determine a subset of object attributes 530 to be priority object attributes 546. In examples, the pre-trained attribute selection model 540 may receive the user attributes 525 and the object attributes 530 and predict the most relevant user attributes 525 and object attributes 530 to include in the prompt 535. In examples, the most relevant user attributes 525 and object attributes 530 may be considered to be high priority attributes, for example, priority user attributes 545 and priority object attributes 546 and may be prioritized for generating the personalized textual description 575. In examples, the LLM may be instructed to consider the attributes in a given priority order, or in other examples the LLM could apply a filter or a threshold and only feed attributes above a priority threshold to the LLM as inputs. In examples, the pre-trained attribute selection model 540 may rank user attributes 525 and object attributes 530 in order of priority, after a pool of user attributes 525 and object attributes 530 have been extracted, or during attribute extraction. In other examples, the attribute selection model 540 may be a non-ML product similarity matrix, or another non-ML solution

In examples, other pre-processing of extracted attributes or domain-specific training may be required before user attributes 525 or object attributes 530 can be provided to the LLM. In examples, user attributes 525 and optionally, object attributes 530 may be provided to an LLM in the form of embeddings or tokens.

In examples, having obtained the user attributes 525 to include in the prompt 535 (and optionally having selected a priority subset of the obtained user attributes as priority user attributes 545 to include in the prompt 535), the prompt generator 500 generates the prompt 535 to the LLM. The prompt generator 500 may, for example, format the user attributes 525 into a structured list (and may list the user attributes 525 with the attribute category, if available) and insert instructions to the LLM to instruct the LLM to generate the personalized textual description 575 based on the listed user attributes 525. The inserted instructions may also provide an example text, for example, an existing source text 515 including a textual description associated with a webpage or stored in a database, or another source text 515 (e.g., a bulleted list) or the prompt 535 may include instructions to tailor the source text 515 by replacing specific words or phrases in the source text 515 based on the user attribute.

For example, the prompt generator 500 may obtain the following user attributes 525 for a user having the user attribute “woman” in the category [gender], and additional user attributes 525 “lives in New York City” in the category [geographic location] and “fitness” in the category [interest]. The prompt generator 500 may format these user attributes 525 into a list and insert instructions to the LLM to generate the following example prompt (example 1):
Revise the original textual description given below to produce a new one that is specifically tailored to be relevant to a user with the user attributes given below.
Original textual description: Energy Fitness is the premier fitness center for health-conscious individuals across the United States! This accessible and affordable gym provides an ideal space for workouts, from strength to cardio or a full range of fitness classes. Feel your best at Energy Fitness.
User attributes:
Gender: woman
Geographic location: lives in New York City
Interest: fitness

The example prompt of example 1 may be considered to have several main parts. First, there are instructions to the LLM that provide instructions to generate a personalized textual description 575 by tailoring the original textual description (e.g., source text 515) to reflect the user attributes 525 provided. This is followed by a separator (in this case, multiple asterisks) and then the source text 515 is identified. This is followed by another separator and then the one or more user attributes 525 to be included in the generated personalized textual description 575.

The generated prompt may be tokenized (by the prompt generator 500 or by a tokenization module of the platform) and the tokens may be included in an API call to the LLM 570. Additionally or alternatively, the generated prompt may be provided to the LLM as-is (e.g., as a sequence of text without the segmentation described above). The generated personalized textual description 575 may then be received by the LLM 570. For example, the generated personalized textual description 575 for the prompt of example 1 may be (example 2):
Energy Fitness is the premier fitness center for women in New York City! This female-friendly gym provides an ideal space for workouts, from strength to cardio or a full range of fitness classes. Feel your best at Energy Fitness.

Notably, because the generated prompt includes instructions to revise the source textual description to produce a new description that is specifically tailored to be relevant to a buyer with the provided user attributes 525, the generated personalized textual description 575 aims to appeal to specific users having certain user attributes 525.

In another example, the prompt generator 500 may obtain the following object attributes 530 for an object having the object attribute 530 “Energy Fitness” in the category [name] and additional object attributes 530 “20,000 square ft.” in the category [size], “123 XYZ Street, New York City, New York” in the category [address] and “Fully accessible; cardio equipment; strength training; range of fitness classes; juice bar on-site” under the category [amenities]. For example, the prompt generator 500 may also obtain the following user attributes 525 for a user having the user attribute “woman” in the category [gender], and additional user attributes 525 “lives in New York City” in the category [geographic location] and “fitness” in the category [interest]. The prompt generator 500 may format these user attributes 525 into a list and insert instructions to the LLM 570 to generate the following example prompt (example 3):
Generate a textual description for the following object using the information below and specifically tailor the description to be relevant to a buyer with the user attributes given below.
Object name: Energy Fitness
Object size: 20,000 square ft.
Object address: 123 XYZ Street, New York City, New York
Object amenities: Fully accessible, cardio equipment, strength training, range of fitness classes, juice bar on-site
User Attributes:
Gender: woman
Geographic location: lives in New York City
Interest: fitness

The example prompt of example 3 may be considered to have several main parts. First, there are instructions to the LLM 570 that provide instructions to generate a personalized textual description 575 for the given object that is specifically tailored to be relevant to a buyer with the user attributes 525 provided. This is followed by a separator (in this case, multiple asterisks) and then the one or more object attributes 530 are identified. This is followed by another separator and then the one or more user attributes 525 to be included in the generated personalized textual description 575.

In some embodiments, for example, the inserted instructions for the prompt in example 3 may include one or a few examples of what the generated description should look like. In some embodiments, the one or a few examples can be automatically generated using data from the object database 560. For example, the object database 560 may store the set of object attributes 530 for each object as well as a source object description (if available) for each object. The prompt generator 500 may select one or a few object descriptions and the associated set of object attributes 530 from the object database 560, format the object attributes 530 and object description into the form of an example (according to defined rules, such as listing the object attributes 530 followed by the object description and labelling this as an example), and insert the result as an example in the instructions to the LLM 570. For example, the prompt generator 500 may automatically select one or a few descriptions of objects randomly from the object database 560, may select descriptions of objects in a similar category as the target object for which the object description is to be generated, may select descriptions of objects found in a similar setting, may select descriptions of objects with similar attributes or categories of attributes, etc. If the object description to be generated is a sellable object description (e.g., a commercial product), the selected object description(s) may be product descriptions of other products belonging to the same account (e.g., sold by the same store), product descriptions of products having high sales, etc.

The generated prompt may be tokenized (by the prompt generator 500 or by a tokenization module of the platform) and the tokens may be included in an API call to the LLM 570. Additionally or alternatively, the generated prompt may be provided to the LLM as-is (e.g., as a sequence of text without the segmentation described above). The generated personalized textual description 575 may then be received by the LLM 570. For example, the generated personalized textual description 575 for the prompt of example 3 may be (example 4):
Energy Fitness welcomes you to feel your best at New York's premier fitness center for women! At 20,000 square feet, this incredible facility has all of the amenities you could want after a hard day in the city. Fully accessible, this female-friendly gym is ideal for your preferred workout, from cardio, strength training or a wide range of fitness classes. And visit our on-site juice bar to enjoy a refreshing post-workout treat.

Examples 1 and 3 show a relatively simple prompt that may be generated by the prompt generator 500, in accordance with examples of the present disclosure. In another example, the prompt generator 500 may insert a predefined sequence of instructions preceding the formatted list of user attributes 525 and optionally, the formatted list of object attributes 530. A lengthier sequence of instructions may be useful to prompt the LLM 570 to generate a personalized textual description 575 according to a certain style or format. For example, the prompt generator 500 may generate the following prompt (example 5):
Follow these instructions in priority order:
1. Use the below information to write a product description.
2. Tailor the description to a potential buyer with the buyer attributes listed below.
3. Don't invent anything.
4. Don't go over 100 words.
Product name: Silver Coffee Table
Features:- Modern
   Built-in storage
   Minimalist design
   Accent piece
User Attributes:
Gender: woman
Geographic location: lives in New York City

In example 5, the sequence of instructions includes step 3 that instructs the LLM 570 to tailor the product description to a potential buyer with the buyer attributes listed below. The generated prompt may be tokenized (by the prompt generator 500 or by a tokenization module of the platform) and the tokens may be included in an API call to the LLM 570. Additionally or alternatively, the generated prompt may be provided to the LLM as-is (e.g., as a sequence of text without the segmentation described above). The generated personalized textual description 575 may then be received by the LLM 570. For example, the generated personalized textual description 575 for the prompt of example 5 may be (example 6):
This silver coffee table is the perfect addition to any stylish New York apartment. Its minimalist design is modern and the built-in storage will help you maximize your space. This feminine table is the accent piece you didn't know you were missing!

In examples, the generated personalized textual description 575 is received from the LLM 570 and may be presented to a user device. For example, the platform may receive the generated description from the LLM 570 as a response to an API call, and the platform may send data to the user device over a communication link (e.g., over a wireless network) to enable the description to be displayed on the user device.

In examples, providing a personalized textual description 575 to a user device takes place during runtime on the user device. In examples, the data for a webpage (e.g., a product webpage) that is stored on the system includes the source text 515. For example, when a user requests to view a webpage, the system retrieves the user record(s) 505 and generates the personalized textual description 575, and provides a modified webpage including the substituted personalized textual description 575 in real-time, in response to the request. In examples, in providing the modified webpage to the user, no permanent changes are made to the source text 515 stored on the system.

Alternatively, in some embodiments, one or more personalized textual descriptions 575 (e.g., best-selling products or products most likely to be of interest) may be automatically generated and pre-loaded or cached by a browser when a buyer first visits any page on a website (e.g., homepage, About Us page, etc.). For example, a user may land on a merchant homepage page and the prompt generator 500 may pre-emptively generate and pre-load one or more personalized textual descriptions 575 corresponding to one or more best-selling products that the merchant offers, in advance of the user navigating to the associated product pages. In examples, cached or pre-loaded textual descriptions may be regenerated after each buyer event (e.g., new search query, new product page view, new item added to cart, etc.) to reflect changes in user behavior or updated user attributes. For example, a user may visit a merchant website that offers specialty cheese and wine. In examples, the user may view a wine “A” and a wine “B” and decide to add wine “B” to their cart. In examples, the user may then view cheese product “X” that pairs very well with the wine “A” that the user viewed previously but that is not in the cart. In examples, the prompt generator 500 may re-generate and pre-load a personalized textual description 575 for cheese product “X” that reflects that wine “A” pairs well with cheese product “X”.

A series of example use cases will now be described:

Example Use case 1: Customization based on co-purchase behavior. For example, based on recent commerce events, the personalized textual description 575 might include a line such as “This X pairs well with Z” (where Z is something the user has in an active cart or has recently purchased/browsed). In another example, based on a recent commerce event (e.g., the purchase of an item with certain specifications, such as a camera) the personalized textual description 575 may be personalized to highlight that a product being viewed is incompatible with the previously purchased item, and may suggest an alternate item that is compatible. For example, the textual description might read “this accessory won't fit the camera that you purchased last week, maybe try this one instead”.

Example Use case 2: Customization based on geography. For example, based on the geographic region of the user, the personalized textual description 575 may read “This X is perfect for cheering on the Atlanta Falcons” if the user is in Atlanta or has bought tickets to an Atlanta Falcons game. In another example, based on geographic region, a personalized textual description 575 may read “This is the perfect X for taking a walk along the harbor” if the user lives in Sydney. In another example, based on the geographic region, a personalized textual description 575 may be personalized to highlight object attributes 530 that have been shown to appeal to other customers in the same region, e.g. colors with cultural significance.

Example Use case 3: Customization based on age/life stage. For example, a personalized textual description 575 crafted for a 30 year old woman living in an urban area may have a different style and may highlight different needs, benefits or uses of the product, than a personalized textual description 575 crafted for a 75 year old man living in a rural setting. In another example, a personalized textual description 575 crafted for a “new mom” or “new dad” may have a different style than a personalized textual description 575 crafted for a 75 year old retired individual.

Example Use case 4: Customization based on objects with similar object attributes. For example, a personalized textual description 575 crafted for a user who has purchased a number of gray apparel items recently may be personalized to prioritize object attributes 530 that align with preferred colors (e.g., “These pants even come in gray!”) In another example, a personalized textual description 575 crafted for a user who has purchased a number of items that share attributes such as “soft”, “stretchy” or “comfortable” may be personalized to highlight that an object attribute 530 of the object being viewed by the user is also “soft”.

Example Use case 5: Customization based on stock or inventory levels. For example, a personalized textual description 575 may be generated to reflect current stock levels or variations of products on hand.

It should be appreciated that the operations performed by the prompt generator 500 to generate personalized textual descriptions 575 in response to requests (e.g., a request to view a webpage) should be performed in real-time or near real-time. For example, there should be negligible delay (e.g., a time delay of no more than a few 100 ms) between receiving a request and providing a personalized textual description 575 for display on a user device, so that a response to the request is not delayed by the prompt generator 500.

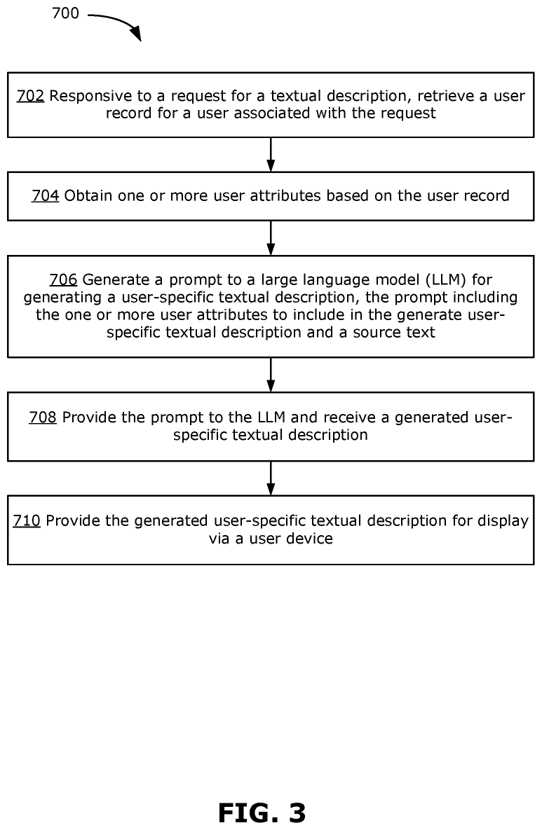

FIG. 3 is a flowchart of an example method 700 for an example embodiment of the present disclosure, which may be performed by a computing system, in accordance with examples of the present disclosure. For example, a processing unit of a computing system (e.g., the processor 402 of the computing system 400 of FIG. 2) may execute instructions (e.g., instructions of the prompt generator 500) to cause the computing system to carry out the example method 700. The method 700 may, for example, be implemented by an online platform or a server.

At an operation 702, in response to a request for a textual description, the prompt generator 500 obtains one or more user record(s) 505 for a user associated with the request. As described above, the user record(s) 505 may be obtained by being received from a user device and/or from an user profiles database 550, for example.

At an operation 704, the prompt generator 500 obtains one or more user attributes 525 for the user based on the user record(s) 505.

At an operation 704, the prompt generator 500 obtains one or more user attributes 525 for the user based on the user record(s) 505.

At an operation 706, a prompt 535 to a LLM 570 is generated (e.g., by the prompt generator 500). The generated prompt 535 includes the user attributes 525 obtained at the operation 704 to include in the generated textual description 575 and a source text 515. In some examples, the source text 515 may be predefined and stored along with the data for a webpage (e.g., a product webpage) that is associated with the request, or in other examples the source text 515 may be received from a database (e.g., an object database 560). In some examples, the user attributes 525 may be provided in the form of embeddings. For example, an embedding may be a social media-based embedding that maps high-dimensional user data gathered from activity on social media platforms or channels to a low dimensional embedding space, thereby capturing associated user attributes.

At the operation 708, LLM 570 (which may be a generative pre-trained transformer LLM, such as GPT-3 or ChatGPT) is prompted to generate a user-specific textual description 575. In examples, the generated prompt 535 is provided to the LLM 570 (e.g., via an API call to a remote LLM). For example, the generated prompt 535 may be converted to a set of tokens (e.g., using a suitable tokenization algorithm or software). For example, the prompt may be segmented into a sequence of text segments and each text segment may be converted to a NLP token (e.g., using a token lookup) while preserving the sequential order of the text segments. Then the set of tokens may be provided to the LLM 570 (e.g., via an API call) in sequential order. A generated user-specific textual description 575 may then be received in response to the API call. Additionally or alternatively, the generated prompt may be provided to the LLM as-is (i.e. as a sequence of text without the segmentation described above).

At an operation 710, the generated user-specific textual description 575 is presented for display via a user device. For example, the generated user-specific textual description 575 may be used to update a webpage. For example, if method 700 is performed to generate a product description for a product (e.g., a product that is purchasable from an online store), the generated user-specific textual description 575 may be a product description that may be used to update a product page related to the product. In examples, the generated user-specific textual description may be automatically substituted for a generic source text 515 on a webpage or other user interface (e.g., a mobile app screen, a React component, or a physical display). Alternatively, the generated personalized textual description 575 may be generated and provided to a user without substituting a source text 515.

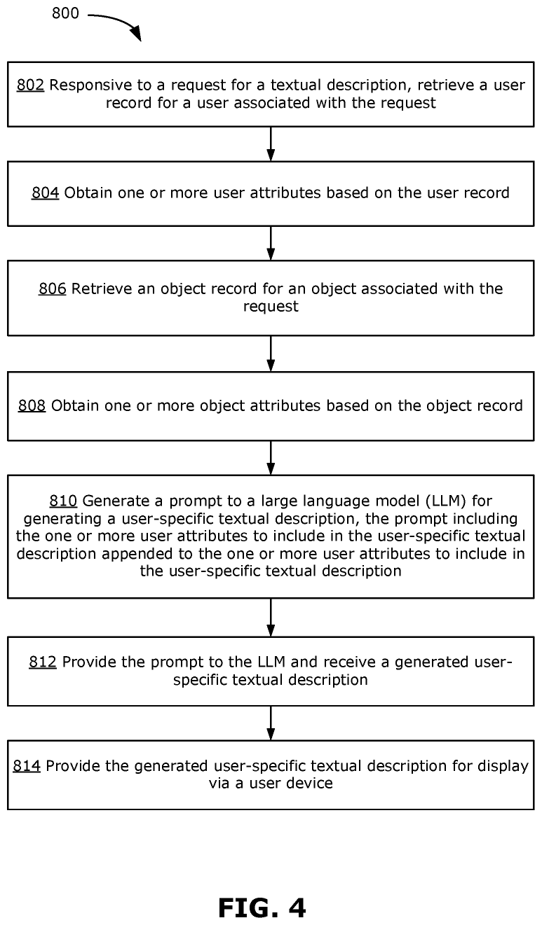

FIG. 4 is a flowchart of an example method 800 for an example embodiment of the present disclosure, which may be performed by a computing system, in accordance with examples of the present disclosure. For example, a processing unit of a computing system (e.g., the processor 402 of the computing system 400 of FIG. 2) may execute instructions (e.g., instructions of the prompt generator 500) to cause the computing system to carry out the example method 800. The method 800 may, for example, be implemented by an online platform or a server.

At an operation 802, in response to a request for a textual description, the prompt generator 500 obtains one or more user record(s) 505 for a user associated with the request. As described above, the user record(s) 505 may be obtained by being received from a user device and/or from an user profiles database 550, for example.

At an operation 804, the prompt generator 500 obtains one or more user attributes 525 for the user based on the user record(s) 505.

At an operation 806, the prompt generator 500 obtains one or more object record(s) 510 for an object associated with the request. As described above, the object record(s) 510 may be obtained from an object database 560, for example.

At an operation 808, the prompt generator 500 obtains one or more object attributes 530 for the object based on the object record(s) 510.

At an operation 810, a prompt 535 to a LLM 570 is generated (e.g., by the prompt generator 500). The generated prompt 535 includes the user attributes 525 obtained at the operation 804 appended to the object attributes 530 obtained at the operation 808, to include in the generated textual description 575. In some examples, the user attributes 525 and the object attributes 530 may be provided in the form of embeddings. For example, an embedding may be a social media-based embedding that maps high-dimensional user data gathered from activity on social media platforms or channels to a low dimensional embedding space, thereby capturing associated user attributes.

At the operation 812, LLM 570 (which may be a generative pre-trained transformer LLM, such as GPT-3 or ChatGPT) is prompted to generate a user-specific textual description 575. In examples, the generated prompt 535 is provided to the LLM 570 (e.g., via an API call to a remote LLM). For example, the generated prompt 535 may be converted to a set of tokens (e.g., using a suitable tokenization algorithm or software). For example, the prompt may be segmented into a sequence of text segments and each text segment may be converted to a NLP token (e.g., using a token lookup) while preserving the sequential order of the text segments. Then the set of tokens may be provided to the LLM 570 (e.g., via an API call) in sequential order. A generated user-specific textual description 575 may then be received in response to the API call. Additionally or alternatively, the generated prompt may be provided to the LLM as-is (i.e. as a sequence of text without the segmentation described above).

At an operation 814, the generated user-specific textual description 575 is presented for display via a user device. For example, the generated user-specific textual description 575 may be used to update a webpage. For example, if method 800 is performed to generate a product description for a product (e.g., a product that is purchasable from an online store), the generated user-specific textual description 575 may be a product description that may be used to update a product page related to the product. In examples, the generated user-specific textual description 575 may be automatically substituted for a generic source text 515 on a webpage or other user interface (e.g., a mobile app screen, a React component, or a physical display). Alternatively, the generated personalized textual description 575 may be generated and provided to a user without substituting a source text 515.

### An Example E-Commerce Platform

Although integration with a commerce platform is not required, in some embodiments, the methods disclosed herein may be performed on or in association with a commerce platform such as an e-commerce platform. Therefore, an example of a commerce platform will be described.

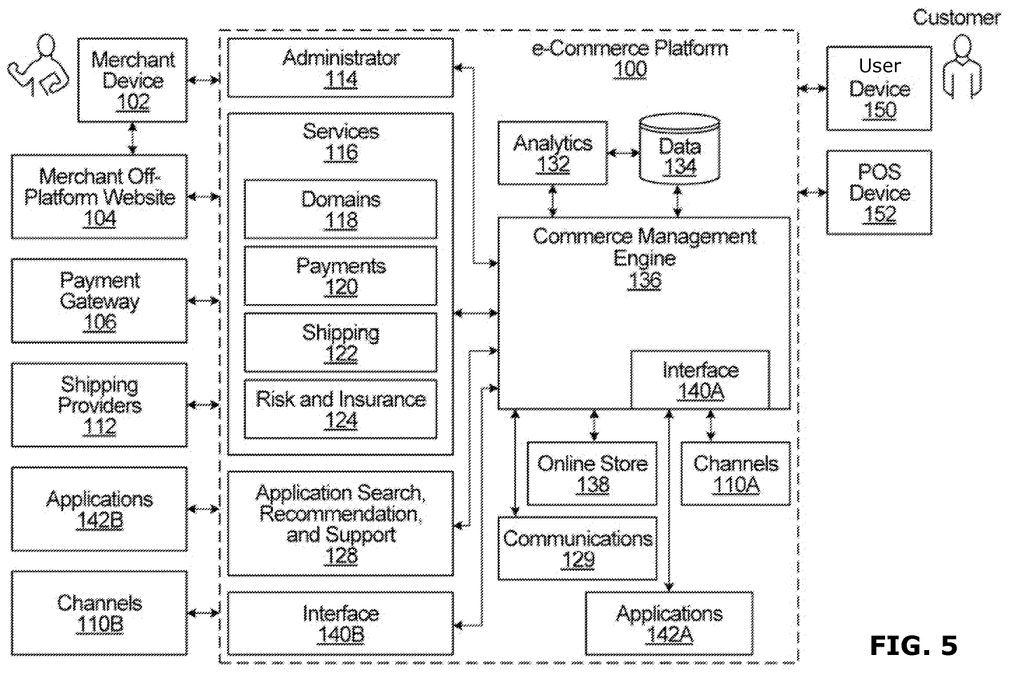

FIG. 5 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 5, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment services 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

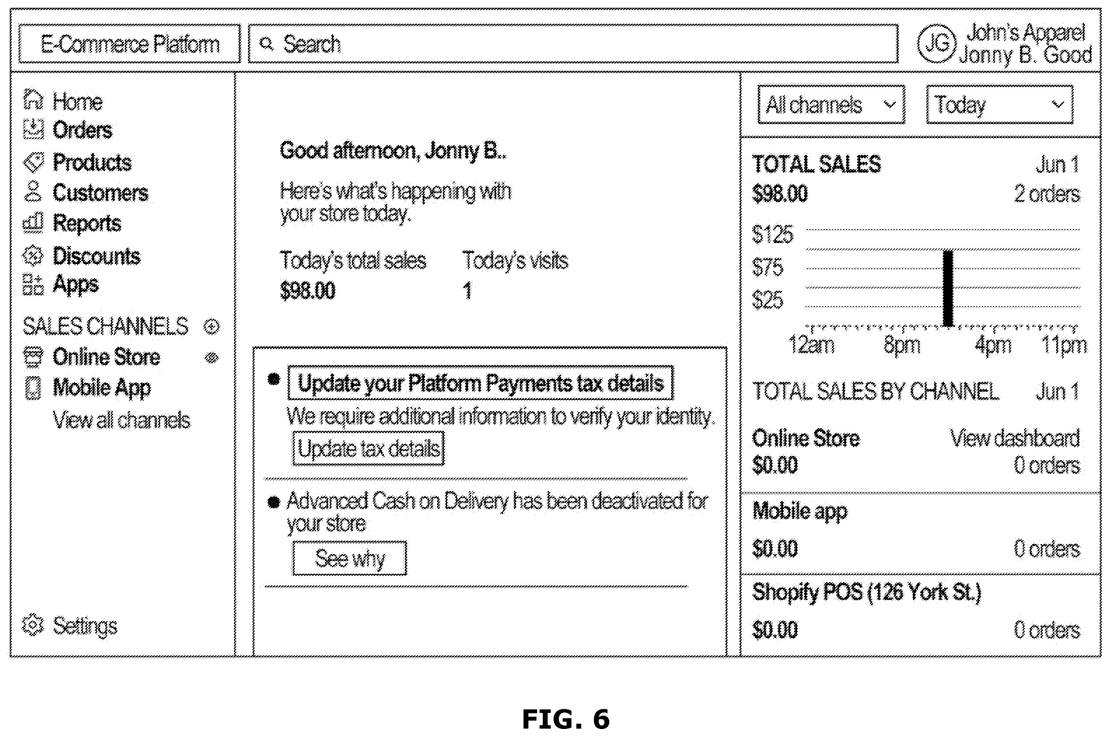

FIG. 6 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalogue, managing orders, and/or the like. In some embodiments, the merchant may be able to access the different sections of the administrator 114 by using a sidebar, such as the one shown on FIG. 3. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 2, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales) (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

In some examples, the applications 142A-B may include an application that enables a user interface (UI) to be displayed on the customer device 150. In particular, the e-commerce platform 100 may provide functionality to enable content associated with an online store 138 to be displayed on the customer device 150 via a UI.

The methods and systems (e.g., prompt generator 500) as disclosed herein may be provided by the e-commerce platform as an online service to enable a user to conveniently and efficiently generate a personalized textual description (e.g., for generating a product description for a product page or a product catalog a description of a photo, a description of an individual, a description of a location etc.). It should be understood that the methods and systems disclosed herein may be provided as an online service by any other online platform (e.g., SaaS platform) without being limited to the e-commerce platform. The online platform may provide applications that serve as an interface layer between the user and the LLM, to enable the user to more effectively and efficiently make use of the LLM to generate a personalized textual description.

Examples of the present disclosure may enable a LLM to be prompted to generate a personalized textual description using user attributes (e.g., related to an individual user's preferences and needs) as inputs. Examples of the present disclosure may enable the generated personalized textual description to be automatically or semi-automatically generated, which may provide for greater efficiency and/or reduced need for user inputs. The disclosed solution may improve the performance of e-commerce platforms or merchant websites by presenting textual descriptions to specific users in a manner that is more relevant and appealing to the user.

Although the present disclosure has described a LLM in various examples, it should be understood that the LLM may be any suitable language model (e.g., including LLMs such as GPT-3 or ChatGPT, as well as other language models such as BART, among others). Additionally, it should be understood that the present disclosure is not limited to any particular language. Although English has been used in various examples, the present disclosure may be equally applicable to other human languages.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer system comprising:
a processing unit configured to execute computer-readable instructions to cause the system to:
responsive to a request for a textual description, retrieve a user record for a user associated with the request;
obtain one or more user attributes based on the user record;
generate a prompt to a large language model (LLM) for generating a user-specific textual description, the prompt including the one or more user attributes to include in the generated user-specific textual description and a source text;
provide the prompt to the LLM and receive a generated user-specific textual description; and
provide the generated user-specific textual description for display via a user device.

2. The system of claim 1, wherein the processing unit is configured to execute computer-readable instructions to obtain the one or more user attributes based on the user record by:
extracting, by a pre-trained attribute extraction model, the one or more user attributes from the user record.

3. The system of claim 2, wherein the processing unit is configured to execute computer-readable instructions to further cause the system to:
retrieve an object record for an object associated with the request;
obtain one or more object attributes based on the object record;
append the one or more user attributes to the one or more object attributes; and
generate the prompt to the LLM for generating the user-specific textual description, the prompt including the one or more user attributes to include in the generated user-specific textual description appended to the one or more object attributes to include in the generated user-specific textual description.

4. The system of claim 3, wherein the processing unit is configured to execute computer-readable instructions to obtain the one or more object attributes by:
extracting, by a pre-trained attribute extraction model, the one or more object attributes that are relevant to the user attributes, from the object record.

5. The system of claim 4, wherein in extracting the one or more object attributes and the one or more user attributes, the processing unit is configured to execute computer-readable instructions to further cause the system to:
determine, by the pre-trained attribute extraction model, one or more priority object attributes from the extracted object attributes;
determine, by the pre-trained attribute extraction model, one or more priority user attributes from the extracted user attributes;
append the one or more priority user attributes to the one or more priority object attributes; and
generate the prompt to the LLM for generating the user-specific textual description, the prompt including the one or more priority user attributes to include in the generated user-specific textual description appended to the one or more priority object attributes to include in the generated user-specific textual description.

6. The system of claim 1, wherein the one or more user attributes is an embedding.

7. The system of claim 3, wherein the one or more object attributes is an embedding.

8. The system of claim 1, wherein the source text is a source product description for a product associated with the request, the prompt to the LLM includes instructions to generate a user-specific product description for the product, and the generated user-specific textual description is a generated user-specific product description.

9. The system of claim 1, wherein the user record comprises at least one of:
a current browsing activity record;
a previous transaction event record;
a previous browsing activity record;
a previous search query; or
a user profile.

10. The system of claim 1, wherein the user attributes include at least one of:
a user demographic attribute;
a user preference attribute; or
a user need attribute.

11. The system of claim 1, wherein the processing unit is configured to execute computer-readable instructions to further cause the system to provide the prompt to the LLM as a set of tokens.

12. The system of claim 1, wherein the LLM is a generative pre-trained transformer LLM.

13. A method comprising:
responsive to a request for a textual description, retrieving a user record for a user associated with the request;
obtaining one or more user attributes based on the user record;
generating a prompt to a large language model (LLM) for generating a user-specific textual description, the prompt including the one or more user attributes to include in the generated user-specific textual description and a source text;
providing the prompt to the LLM and receive a generated user-specific textual description; and
providing the generated user-specific textual description for display via a user device.

14. The method of claim 13, wherein obtaining the one or more user attributes based on the user record comprises:
extracting, by a pre-trained attribute extraction model, the one or more user attributes from the user record.

15. The method of claim 14, further comprising:
prior to retrieving the user record, retrieving an object record for an object associated with the request;
obtaining one or more object attributes based on the object record;
and generating the prompt to the LLM for generating the user-specific textual description, the prompt including the one or more user attributes to include in the generated user-specific textual description appended to the one or more object attributes to include in the generated user-specific textual description.

16. The method of claim 15, wherein obtaining the one or more object attributes based on the object record comprises:
extracting, by a pre-trained attribute extraction model, the one or more object attributes that are relevant to the user attributes, from the object record.

17. The method of claim 16, wherein extracting the one or more object attributes and the one or more user attributes comprises:
determining, by the pre-trained attribute extraction model, one or more priority object attributes from the extracted object attributes;
determining, by the pre-trained attribute extraction model, one or more priority user attributes from the extracted user attributes;
and
generating the prompt to the LLM for generating the user-specific textual description, the prompt including the one or more priority user attributes to include in the generated user-specific textual description appended to the one or more priority object attributes to include in the generated user-specific textual description.

18. The method of claim 13, wherein the one or more user attributes is an embedding.

19. The method of claim 15, wherein the one or more object attributes is an embedding.

20. The method of claim 13, wherein the request is a request received from a user device to view a webpage associated with a product, and wherein the method further comprises:
in response to the request, providing a modified webpage for display on the user device, the modified webpage including the user-specific textual description.

21. The method of claim 20, wherein data for the webpage stored on the system includes the source text, and wherein the modified webpage provided to the user device has the user-specific textual description substituted in real-time in response to the request.

22. The method of claim 13, wherein the source text is a source product description, the prompt to the LLM includes instructions to generate a user-specific product description for a product associated with the source product description, and the generated user-specific textual description is a generated user-specific product description.

23. The method of claim 13, wherein the user record comprises at least one of:
a current browsing activity record;
a previous transaction event record;
a previous browsing activity record;
a previous search query; or
a user profile.

24. A computer-readable medium storing instructions that, when executed by a processor of a computing system, cause the computing system to:
responsive to a request for a textual description, retrieve a user record for a user associated with the request;
obtain one or more user attributes based on the user record;
generate a prompt to a large language model (LLM) for generating a user-specific textual description, the prompt including the one or more user attributes to include in the generated user-specific textual description and a source text;
provide the prompt to the LLM and receive a generated user-specific textual description; and
provide the generated user-specific textual description for display via a user device.
